(19) United States
(12) Patent Application Publication
(10) Pub. No.: US 2023/0186023 A1
(43) Pub. Date: Jun. 15, 2023

(54) AUTOMATICALLY ASSIGN TERM TO TEXT DOCUMENTS

(71) Applicant: International Business Machines Corporation, Armonk, NY (US)

(72) Inventors: Yannick Saillet, Stuttgart (DE); Alexander Lang, Stuttgart (DE); Robert Kern, Karlsruhe (DE); Gudrun Kaufmann, Falkensee (DE)

(21) Appl. No.: 17/548,651

(22) Filed: Dec. 13, 2021

(51) Int. Cl. G06F 40/284; G06F 16/93

(52) U.S. Cl. CPC G06F 40/284; G06F 16/93

(57) ABSTRACT

In an approach, a processor receives an unstructured text document. A processor extracts at least one unrecognized token from the unstructured text document. A processor identifies at least one structured data element in a predefined set of data sources, where the at least one structured data element is related to the at least one extracted unrecognized token from the unstructured text document. A processor relates a label associated with the identified at least one structured data element to the unstructured text document.

### BACKGROUND

The present invention relates to a computer-implemented approach for labeling a document, and more specifically, to a computer-implemented approach for labeling an unstructured text document.

Business leaders increasingly realize that enterprise data are one of the key ingredients in driving enterprise transformation and digitization. This is necessary not only for employee empowerment but also for better enterprise analytics and is the foundation for machine learning and artificial intelligence driven enterprise applications. On the other side, enterprises store and technically manage more data than they believe. One of the problems with not using this data may be that “the company does not know what it knows,” meaning that too much data—often in the form of unstructured data—is simply stored without reference to business contexts.

An automatic business classification and term assignment of data assets may be a key functionality for enterprise catalogs and a critical problem for enterprises using such cover locks. With the advent of data lakes, companies have a strong need for an automated process to find, catalog and/or categorize data assets from the data lake into the catalog data so that analysts can easily find such data assets for reuse. In order to be searchable, cataloged assets need to be classified and associated with relevant business terms as, for example, are defined in a business glossary of a specific company. The same terms may have different meanings for different enterprises. Thus, organization specific categorization may be of high value. It goes without saying that an automatic assignment of business terms to data assets ideally takes place at the time when the data assets are added into the catalog.

Currently known techniques of the term assignment process are focused on structured data only. Some prior art techniques either use metadata of the data contained in structured data sets in order to properly classify the fields of the data sets, assign an appropriate term to them, and, based on the field-level results, assign terms to the data set as a whole.

Practically, almost all of these classification techniques wouldn't work on unstructured documents because the lack of structure and lack of metadata make those classification techniques unusable. On the other side, it is generally accepted that unstructured documents—such as free text documents, e.g., emails and reports, represent the largest amount of data sets that may be available in a data lake. Such unstructured documents are unused sources that could be useful for analytical tasks or as a basis for training data for enterprise-specific machine-learning based applications. However, due to the lack of term assignments, such sources may be extremely difficult to find.

In this context, some documents have been published already: U.S. Pat. No. 9,672,278 B1 discloses a processing platform configured to implement a cluster labeling system for documents comprising unstructured text data. The cluster labeling system comprises a clustering module and a visualization module. The clustering module may implement a topic model generator and is configured to assign each of the documents to one or more of a plurality of clusters based at least in part on one or more topics identified from the unstructured text data using at least one topic model provided by the topic model generator. Additionally, E.P. Patent Application 3,591,539 A1 discloses computerized, automatic processing of unstructured text to extract bits of conduct tech data to which the extracted text can be linked or attributed. Unstructured text is received and text segments within the text are enriched with metadata labels. A machine-learning system is trained on, and used to parse feature values for the text segments and metadata labels to classify text and generate structured text from the unstructured text.

However, the problem remains that existing technologies focus on the text itself and are unable to label the text in the context of meaningful terms of an enterprise-specific context. Furthermore, existing technologies very often require longer texts to apply statistical models to extract terms for the classification.

Hence, there may be a need for a better classification and/or labeling of unstructured documents in order to leverage the content of the unstructured data in a broader enterprise context.

### SUMMARY

According to one aspect of the present invention, a computer-implemented method may be provided. The method may comprise receiving an unstructured text document, extracting at least one unrecognized token from the unstructured text document, identifying at least one structured data element in a predefined set of data sources, wherein the at least one structured data element is related to the at least one extracted unrecognized token from the unstructured text document, and relating a label associated with the identified at least one structured data element to the unstructured text document.

According to another aspect of the present invention, a computer system may be provided. The system may comprise one or more computer processors, one or more computer readable storage media, and program instructions collectively stored on the one or more computer readable storage media for execution by at least one of the one or more computer processors. The program instructions may comprise program instructions to receive an unstructured text document, extract at least one unrecognized token from the unstructured text document, identify at least one structured data element in a predefined set of data sources, wherein the at least one structured data element is related to the at least one extracted unrecognized token from the unstructured text document, and relate a label associated with the identified at least one structured data element to the unstructured text document.

According to another aspect of the present invention, a computer program product may be provided. The computer program product may comprise one or more computer readable storage media and program instructions collectively stored on the one or more computer readable storage media. The program instructions may comprise program instructions to receive an unstructured text document, extract at least one unrecognized token from the unstructured text document, identify at least one structured data element in a predefined set of data sources, wherein the at least one structured data element is related to the at least one extracted unrecognized token from the unstructured text document, and relate a label associated with the identified at least one structured data element to the unstructured text document.

The proposed computer-implemented method may offer multiple advantages, technical effects, contributions and/or improvements:

The concept proposed here focus on one of the pressing needs of enterprise data management, namely, on the general concept related to an unstructured text document. The concept not only relies on longer texts that enable a statistical analysis of terms, but will then have the unstructured text document. Instead, the proposed concept may also be successfully implemented for small text snippets originating from chat entries, exchanged emails, “keyword only” presentations, blogs, or others.

Thereby, existing knowledge in the form of known, structured data may be used successfully to label the unstructured text documents. Organizations may maintain a plurality of different data definitions—starting from like term definitions in structured (e.g., legal) documents (or other metadata), such as an annual report of the company to database metadata—all of which may be used for the concept proposed here. No new terms catalogs or other directories need to be maintained in order to successfully implement the proposed concept successfully. Existing data may be reused or leveraged consequently to bridge the gap between the already existing structured data and new incoming unstructured text documents.

Under another advantageous aspect, the fact may be leveraged is that the structured data are typically already labeled properly so that they may be used in reports, ML applications, analytics and data science projects in respect to data governance and protection rules, and also for the labeling of the new unstructured text documents. Therefore, a consistent labeling strategy may be followed automatically because the value and knowledge may be more in the labelling of those structured data, rather than in the structured data themselves.

And a further advantageous aspect should be mentioned: without a proper classification and/or labeling of the unstructured data, those data typically cannot be used uncontrolled because there may be a risk that they could comprise sensitive information or privacy compromising data. Hence, the labeling of the structured data may be the key to unlock those new types of data for any kind of usage in a company which is required to apply data governance rules.

As a consequence, the proposed technical approach may turn the vast amount of managed unstructured data in an organization into additional valuable sources of insight for human users or as a foundation for machine-learning training techniques to enhance traditional transactional applications or those that address new opportunities.

In the following, additional embodiments of the inventive concept—applicable for the method as well as for the system—will be described.

According to an embodiment of the method, the extracting at least one unrecognized token from the unstructured text document may also comprise determining natural language elements and—in particular, at least one—non-natural-language element. Thereby, the natural language elements may be language elements or tokens which belong to a natural—in particular human oriented and understandable—language, like nouns, verbs, adjectives, adverbs and so on. The non-natural-language elements may finally build the bridge between the unstructured text of the received document and more structured terms typically be used in other areas of an organization. Examples of a natural language may be the English language, the German language, the French language, the Italian language, Spanish-language, and so on.

According to a further developed embodiment, the method may also comprise grouping the non-natural-language tokens into a group of tokens with similar characteristics, i.e., similar format or similar structure. Of course, a grouping may only be possible if more than one non-natural-language token may have been found in the unstructured text document. Otherwise, this method step may be skipped. Examples of such non-natural-language tokens may be, e.g., product numbers used in a company, identifiers for production machines, asset numbers, identifiers for Internet of Things (IoT) devices, or similar. Common ground for such ordering information may be a comparable sequence of characters grouped in alphabetical characters, digits, and other non-alphabetical characters, like, commas, hyphens, etc.

According to an advantageous embodiment of the method, the identifying the at least one structured data element may comprise at least one out of the group comprising (i) searching for at least one data element—i.e., a term, a potential label—in the predefined set of data sources, wherein the at least one data element may comprise as a value at least one of the extracted non-natural-language tokens, and (ii) searching for at least one data element in the predefined set of data sources, wherein the at least one data element may comprise as metadata—in particular, a name, a description, a field name, or the like—at least one of the extracted natural language tokens. If the non-natural-language token may build one of the ends of the bridge from the unstructured text into typical and structured corporate terms, the at least one data element may form the second end of the bridge.

According to an embodiment, the method may also comprise determining a matching score value based on a number of the at least one unrecognized token and recognized tokens—i.e., all recognized tokens which have been extracted from the unstructured text document that have been found—in the data element and a specificity of the extracted tokens. Such a matching score value may be a good measure to express how frequent those tokens have been found in the data element as well as how few have actually been found in other data elements. As a consequence, the higher the number of matches in the data element and the lower the number of matches in the other data elements is, the higher is the matching score value.

According to an additional embodiment, the method may also comprise selecting the data element having the highest score value as the label for the unstructured text document. This way, a good characterizing term for the unstructured text document may have been identified. It may automatically be used as one categorization criterion for the unstructured text document or it may require a confirmation from a human operator.

According to another embodiment of the method, the identifying of at least one structured data element comprises (i) generating a structured data element comprising the extracted non-natural-language tokens as values, (ii) determining domain characteristics for the generated data element and/or (iii) searching, in a predefined set of data sources, for the structured data elements which share the same domain characteristics. As an example for the first option (i), one can imagine to generate a data set where column may represent one group of unrecognized token, and wherein the value of these columns being the unrecognized tokens. An example of the second option (ii) is a determination of a data class that matches the values or a determination of a format or pattern that is common to all values as far as possible.

According to a further advantageous embodiment of the method, the relating the label associated with the identified at least one structured data element to the unstructured text document may also comprise outputting the related label as label suggestion for the unstructured text document, e.g., to a human operator via an I/O device, and receiving a confirmation signal—e.g., also from the human operator—confirming the label suggestion as the confirmed label for the unstructured text document. This may safeguard a secured process in order to not generate nonsense labels for an unstructured text. Finally, the quality of the labelling process may be further increased.

According to another embodiment of the method, the predefined set of data sources may be at least one selection from the group consisting of a database table—in particular, a relational database (e.g., row-oriented), a columnar database, but also metadata of the DB— a data dictionary, a data catalogue —, in particular a business term catalog—a structured file—in particular formats using XML, JSON, YAML, or similar—in a file system or, any other no-SQL database or a graph database, just to name examples. Hence, the pre-assigned set of data sources may comprise a collection of data definitions inside, as well as outside the organization. Finally, it is also possible, to search the Internet for correct labels for the unstructured text document.

According to one embodiment of the method, the selected label may further be ranked—i.e., so to speak in a second dimension—based on context extracted from the unstructured text document. This may include key phrases, terms from a pre-specification or other statistical term extraction from the unstructured text document.

According to another embodiment, the method may also comprise sorting the data elements by the search score value associated with each of the data elements and keeping only those data elements with a search score value above a search score threshold value. This may be a good approach to reduce the computational efficiency of the proposed concept.

### BRIEF DESCRIPTION OF THE DRAWINGS

It should be noted that embodiments of the invention are described with reference to different subject-matters. In particular, some embodiments are described with reference to method type claims, whereas other embodiments are described with reference to apparatus type claims. However, a person skilled in the art will gather from the above and the following description that, unless otherwise notified, in addition to any combination of features belonging to one type of subject—matter, also any combination between features relating to different subject—matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, to which the invention is not limited.

Preferred embodiments of the invention will be described, by way of example only, and with reference to the following drawings:

FIG. 1 shows a flowchart of an embodiment of the inventive computer-implemented approach for labeling an unstructured text document.

FIG. 2 shows a first portion of a flow of an embodiment of the invention.

FIG. 3 shows a second portion of a flow of an embodiment of the invention.

FIG. 4 shows a flowchart of a more implementation near embodiment of the invention.

FIG. 5 shows a block diagram of an embodiment of the inventive text labeling system for labeling unstructured text documents.

FIG. 6 shows an embodiment of a computing system comprising the system according to FIG. 5, in accordance with an embodiment of the invention.

### DETAILED DESCRIPTION

In the context of this description, the following conventions, terms and/or expressions may be used:

The term ‘unstructured text document’ may denote a simple text of any length. It may go down to a short length of a phrase comprising only a couple of words. At the other end, the unstructured text document may be an executive summary, a complete report or a book. Typically, it may be assumed that the length of a paragraph or article may be dealt with. The sub term ‘unstructured’ may represent the information technology (IT) perspective in which natural language text may be described as unstructured or semi-structured data that is not structured in the sense of a structured record. However, it may also be assumed that natural language rules may be applicable to the text so that the text is structured in the sense of the underlying human language.

At the other end of the scale, the unstructured text document may technically also represent a collection of documents of the same type that may be comprised, for instance, in the same folder of a file system or the same column of a data base table.

Typically text documents are analyzed in groups, rather than individually. For instance, a folder may comprise many short documents, each representing the free text description of a support ticket. Those documents are likely to share all the same labels. Analyzing them one by one may be slow and not really conclusive if the documents are very short. But treating the group of documents as if they were one document—in that case the folder containing them is what is analyzed—may give much more tokens that can be grouped as described in the disclosure.

The term ‘labeling’ may denote here that a term—or a short phrase—may be associated with the text document. The text document may also be denoted as the unstructured text document. The label for the text should be assumed as a meaningful label relating to the content of the text document. It may also be seen as a headline, head word, or content describing metadata of the text document. The term associated to the text document may then be denoted as ‘label’. From a more general perspective, labeling could also mean that a new piece of metadata is associated to the document. That could be, e.g., data privacy or business classification, the association to a governance policy that needs to be respected when using this data, etc.

The term ‘unrecognized token’ may denote a term in the text document which may not be associated to a natural language expression. A simple example for such an unrecognized token may be a product number or part number in the service manual for a technical product.

The term ‘structured data element’— or in short, data element—may denote a data element structured in the sense of a structured record of, e.g., a database. Hence, the structured data element may be any element from a database table, a database table name, an element of enterprise catalog, a data dictionary, or the like. It may, e.g., be a part number of a product catalog in the form of, e.g., a product-key or a description of the product in natural language terms.

The term ‘predefined set of data sources’ may denote any document or data source relating to a description of data used in, e.g., an enterprise or a group of enterprises (e.g., a data interchange format). It may relate to a data catalog, reference data or any other form of data description used. Such data descriptions may be enterprise specific or they may be standardized for, e.g., an industry vertical. However, in a specific embodiment and in a broader sense, also data definitions made available via the Internet may be part of the predefined set of data sources.

The term ‘natural language element’ may denote any expression present in a human understandable natural language, like nouns, verbs, adjectives, adverbs, propositions, and so on.

The term ‘non-natural-language element’ may denote any term in the unstructured text document which cannot be characterized as natural language element. Hence, a non-natural-language element is something outside the scope of terms classically defined as vocabulary of a specific language.

The term ‘metadata’ may denote data that describe other data.

The term ‘matching score value’ may denote an integer or a real value (in the mathematical sense) expressing how good a label may relate to the text document to be labeled, or, more specifically, how good the match is from the unrecognized token to the term found in the data sources. It may also be noted that the matching score value may be increased each time the non-natural-language term may be found.

The term ‘specificity’ may denote how specific a found term may be for a certain expression and how badly for other expressions, i.e., the more positive counts for searches in different sources may be found for the term and the less counts can be generated for other terms, the more specific the found term may be for a certain expression. In other words, the term ‘specificity’ may describe the absence of a condition for non-specific terms for the term to refer to a “gold standard” for the term.

The term ‘domain characteristics’ may denote certain attributes for a term so that it may relate to a data class matching the values, or determine a format or pattern that is common for all values. Broadly speaking, domain characteristics may denote common properties that different values or tokens belonging to the same domain—i.e., representing the same type of entity in the real world—may share. For instance, different telephone numbers have the common characteristics that they have the same format, i.e., certain number of digits separated in a certain way. Different postal addresses may have the common characteristics that they share the same frequent common words, like street, avenue, etc. The expectation shall be that different groups of tokens or values sharing the same domain characteristics have a good probability to share the same domain and need common labels.

In the following, a detailed description of the figures will be given. All instructions in the figures are schematic. Firstly, a block diagram of an embodiment of the inventive computer-implemented method for labeling an unstructured text document is given. Afterwards, further embodiments, as well as embodiments of the text labeling system for labeling unstructured text documents will be described.

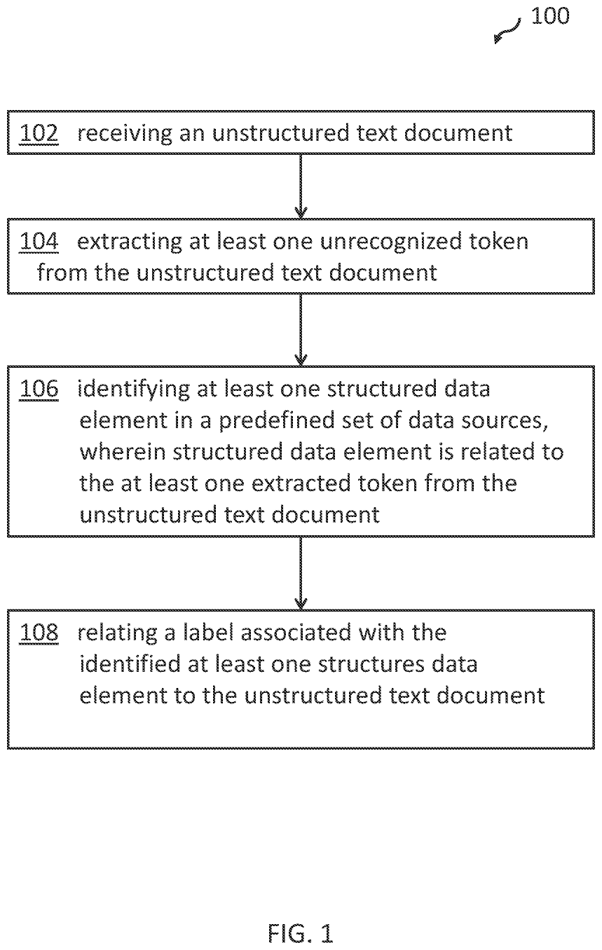

FIG. 1 shows a flowchart of an embodiment of the computer-implemented approach 100 for labeling an unstructured text document. A process receives, 102, an unstructured text document. The unstructured text document may be “naked” which is not labeled, and/or not assigned to a certain category. Basically, there is no information to which the content of the document relates to.

The approach 100 further comprises a process extracting, 104, at least one unrecognized token—e.g., numbers, strings of letters & numbers, all relating to the same general construction roots—from the unstructured text document, a process identifies, 106, at least one structured data element—in general, e.g., an expression from a database table, database table name, element of enterprise catalog, data dictionary, or comparable—in a predefined set of data sources, wherein the at least one structured data element is related to the at least one extracted unrecognized token from the unstructured text document, and a process relates, 108, to a label—in particular, any form of a human readable word or phrase or short expression—associated with the identified at least one structured data element to the unstructured text document.

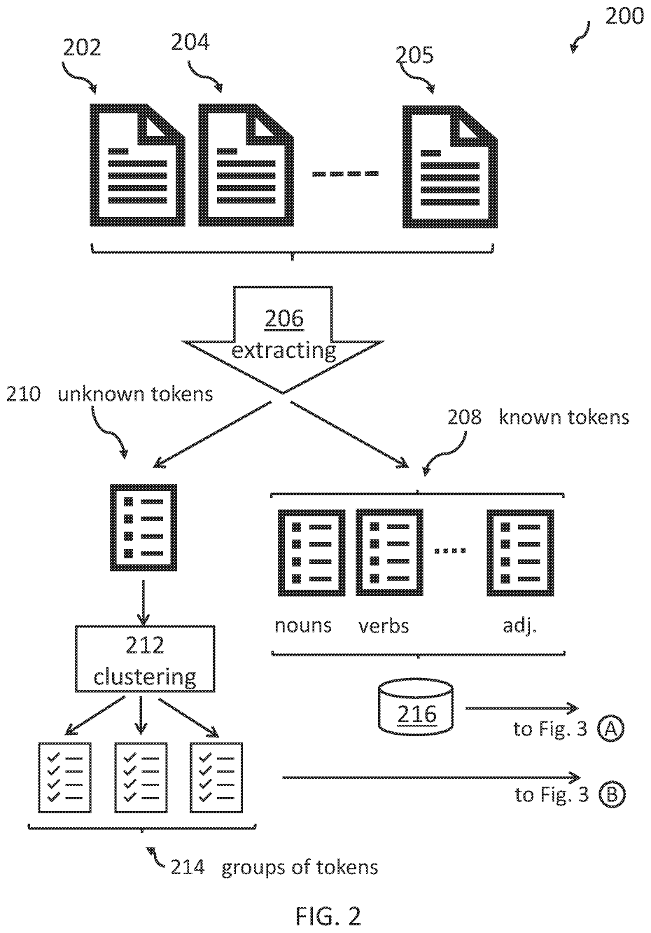

FIG. 2 shows a first portion 200 of a flow of an embodiment of the invention. The process flow starts with incoming unstructured text documents 202, 204, 205 from which a process, 206, extracts known tokens 208 and unknown tokens 210. A process clusters, 212, the unknown tokens into groups 214 of related tokens. The known tokens 208 typically relate to nouns, words, objectives and so on, i.e., known expressions of a human understandable, natural language. The known tokens 208 may also be fed to a thesaurus 216 to identify synonyms of these words. The process flow is then continued on the next figure.

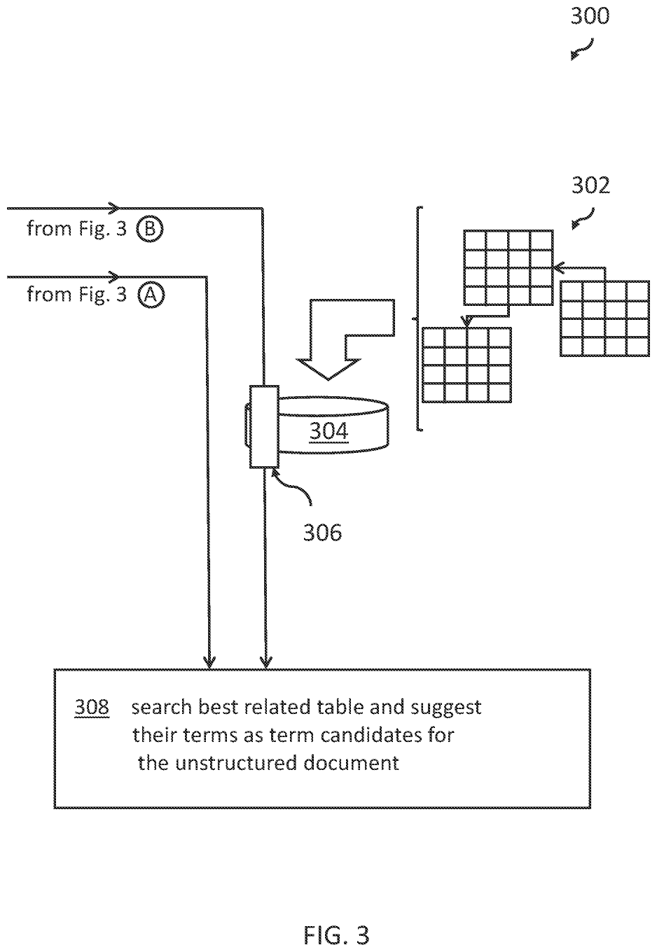

FIG. 3 shows a second portion 300 of a flow of an embodiment of the proposed concept. A process uses (path “B”) each term of the unknown tokens—or a generalized domain term relating to the groups of tokens 214 (compare FIG. 2)— to search, 306, for matching expressions (e.g., in the structured data shown exemplary as tables 302) in one or more known data sources 304 using, e.g., classifiers for the matching process (also other methods may be applicable).

If unsuccessful, a process may use the alternative path “A” to search, 308, for a best related table using the known data sources 304, as well as, or together with, related indices and other metadata using matching score values and specificity values. These terms are then proposed as label candidates for the unstructured document. In some embodiments, the label candidates may need to be confirmed by a human operator (not shown).

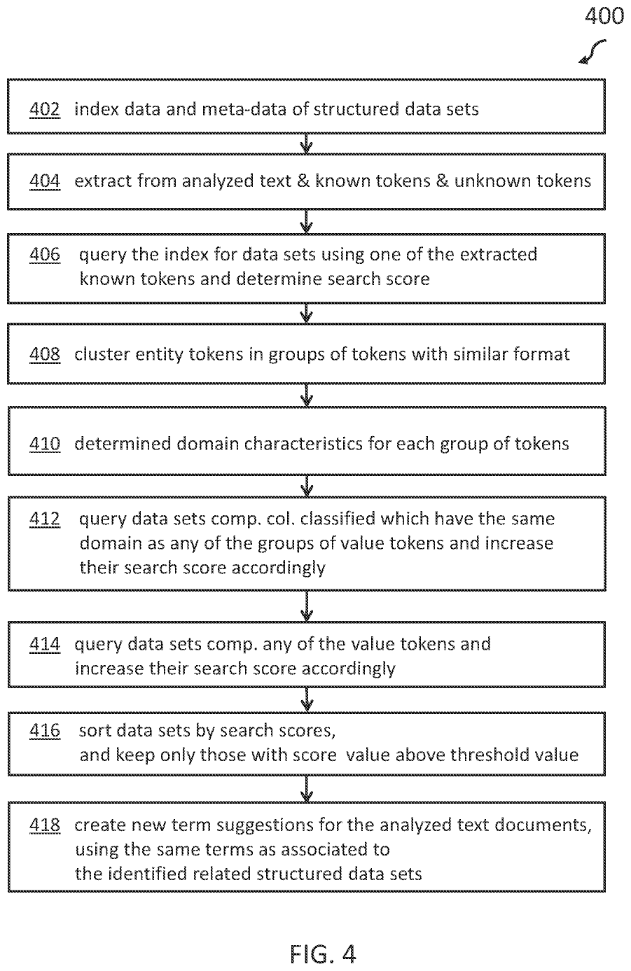

FIG. 4 shows a flowchart 400 of a more detailed implementation of an embodiment of the invention. Firstly, as a preparatory step 402, a process indexes structured data sets and extracts metadata. From the unstructured text data—i.e., the text to be analyzed—a process extracts, 404, known and unknown tokens.

A process searches the generated index for the data sets—i.e., queried, 406— using one of the extracted known tokens, and a search score value may be generated, e.g., the search score value may be increased the more often the extracted unknown token(s) may be found.

Furthermore, a process may cluster, 408, the unknown tokens in groups of tokens having a comparable or similar format, i.e., the format of the structure may follow the same construction rules. As a simple example: two letters followed by 10 digits, followed by another letter.

A process determines, 410, domain characteristics for each group of tokens—i.e., common formats, common repeating words or groups of characters, or common matching data class (in one embodiment, classifiers can be used for this). A process queries, 412, the data sets comprising columns having similar domain characteristics and the search score is increased accordingly. Furthermore, a process queries, 414, the data sets containing any of the value tokens and the search score is increased accordingly.

Using the described general technique, one can avoid that only one characteristic among others that may be used to identify columns sharing the same domain (which could be the case when using a simple classifier). If the group of tokens all have the same very specific format (e.g., like one would have for a group of phone numbers or contract numbers), then finding columns containing values having the same very specific format can be enough to create the relationship between the unstructured document and the data set containing the column.

A process sorts, 416, the data sets by the related search score values and those that are kept have a search score value above a predefined threshold value. A process creates, 418, a new term—i.e., label—suggestion for the analyzed text document. Thereby, the same term as associated with the identified related structured data sets is used.

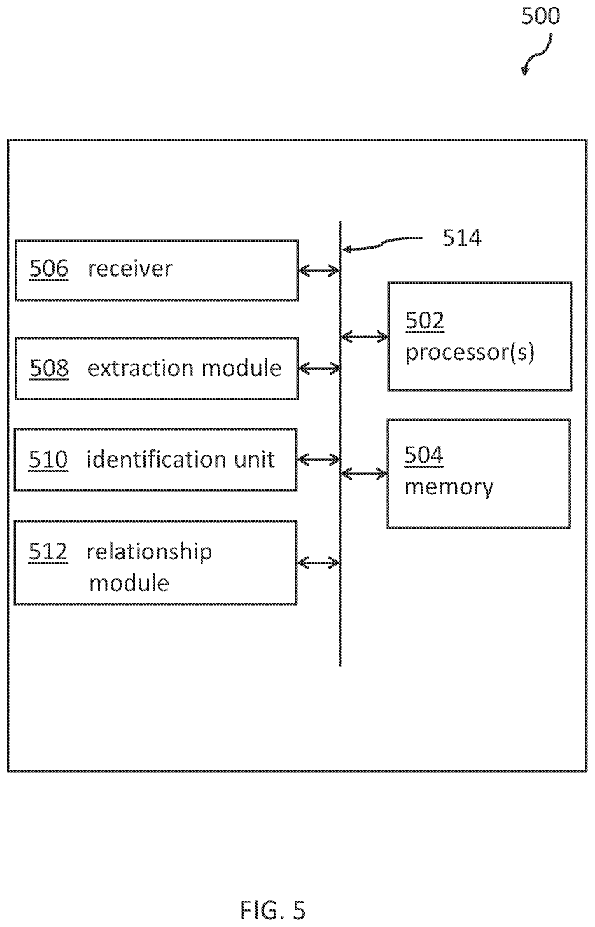

FIG. 5 shows a block diagram of an embodiment of the text labeling system 500 for labeling unstructured text documents. The system 500 comprises a processor 502 and a memory 504, communicatively coupled to the processor 502, wherein the memory 504 stores program code portions that, when executed, enable the processor 502, to receive—in particular, by a receiver 506—an unstructured text document, extract—in particular by an extraction module 508—at least one unrecognized token from the unstructured text document, identify—in particular, by an identification unit 510—at least one structured data element in a predefined set of data sources, wherein the at least one structured data element is related to the at least one extracted unrecognized token from the unstructured text document, and relate—in particular, by a relationship module 512—to a label associated with the identified at least one structured data element to the unstructured text document.

It shall also be mentioned that all functional units, modules and functional blocks—in particular, the processor 502, the memory 504, the receiver 506, the extraction module 508, the identification unit 510 and, the relationship module 512—may be communicatively coupled to each other for signal or message exchange in a selected 1:1 manner. Alternatively the functional units, modules and functional blocks can be linked to a system internal bus system 514 for a selective signal or message exchange.

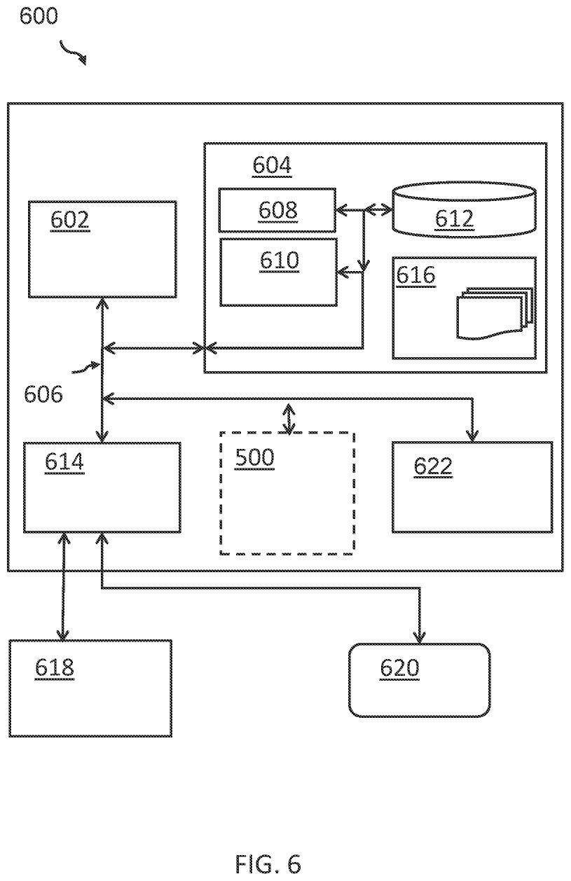

Embodiments of the invention may be implemented together with virtually any type of computer, regardless of the platform being suitable for storing and/or executing program code. FIG. 6 shows, as an example, a computing system 600 suitable for executing program code related to the proposed method.

The computing system 600 is only one example of a suitable computer system, and is not intended to suggest any limitation as to the scope of use or functionality of embodiments of the invention described herein, regardless, whether the computer system 600 is capable of being implemented and/or performing any of the functionality set forth hereinabove. In the computer system 600, there are components, which are operational with numerous other general purpose or special purpose computing system environments or configurations. Examples of well-known computing systems, environments, and/or configurations that may be suitable for use with computer system/server 600 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 600 may be described in the general context of computer system-executable instructions, such as program modules, being executed by a computer system 600. Generally, program modules may include routines, programs, objects, components, logic, data structures, and so on that perform particular tasks or implement particular abstract data types. Computer system/server 600 may be practiced in distributed cloud computing environments where tasks are performed by remote processing devices that are linked through a communications network. In a distributed cloud computing environment, program modules may be located in both, local and remote computer system storage media, including memory storage devices.

As shown in the figure, computer system/server 600 is shown in the form of a general-purpose computing device. The components of computer system/server 600 may include, but are not limited to, one or more processors or processing units 602, a system memory 604, and a bus 606 that couple various system components including system memory 604 to the processor 602. Bus 606 represents one or more of any of several types of bus structures, including a memory bus or memory controller, a peripheral bus, an accelerated graphics port, and a processor or local bus using any of a variety of bus architectures. By way of example, and not limiting, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. Computer system/server 600 typically includes a variety of computer system readable media. Such media may be any available media that is accessible by computer system/server 600, and it includes both, volatile and non-volatile media, removable and non-removable media.

The system memory 604 may include computer system readable media in the form of volatile memory, such as random access memory (RAM) 608 and/or cache memory 610. Computer system/server 600 may further include other removable/non-removable, volatile/non-volatile computer system storage media. By way of example only, a storage system 612 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 606 by one or more data media interfaces. As will be further depicted and described below, memory 604 may include at least one program product having a set (e.g., at least one) of program modules that are configured to carry out the functions of embodiments of the invention.

The program/utility, having a set (at least one) of program modules 616, may be stored in memory 604 by way of example, and not limiting, as well as an operating system, one or more application programs, other program modules, and program data. Each of the operating systems, one or more application programs, other program modules, and program data or some combination thereof, may include an implementation of a networking environment. Program modules 616 generally carry out the functions and/or methodologies of embodiments of the invention, as described herein.

The computer system/server 600 may also communicate with one or more external devices 618 such as a keyboard, a pointing device, a display 620, etc., one or more devices that enable a user to interact with computer system/server 600; and/or any devices (e.g., network card, modem) that enable computer system/server 600 to communicate with one or more other computing devices. Such communication can occur via Input/Output (I/O) interfaces 614. Still yet, computer system/server 600 may communicate with one or more networks such as a local area network (LAN), a general wide area network (WAN), and/or a public network (e.g., the Internet) via network adapter 622. As depicted, network adapter 622 may communicate with the other components of the computer system/server 600 via bus 606. It should be understood that, although not shown, other hardware and/or software components could be used in conjunction with computer system/server 600. Examples, include, but are not limited to: microcode, device drivers, redundant processing units, external disk drive arrays, RAID systems, tape drives, and data archival storage systems, etc.

Additionally, the text labeling system 500 for labeling unstructured text documents may be attached to the bus system 514.

The descriptions of the various embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

Finally, the inventive concept may be summarized by the following clauses:

Clause 1. A computer-implemented method comprising receiving, by one or more processors, an unstructured text document, extracting, by one or more processors, at least one unrecognized token from the unstructured text document, identifying, by one or more processors, at least one structured data element in a predefined set of data sources, wherein the at least one structured data element is related to the at least one extracted unrecognized token from the unstructured text document, and relating, by one or more processors, a label associated with the identified at least one structured data element to the unstructured text document.

Clause 2. The computer-implemented method of clause 1, wherein extracting the at least one unrecognized token from the unstructured text document further comprises determining, by one or more processors, natural language elements and non-natural-language elements.

Clause 3. The computer-implemented method of claim 2, further comprising grouping, by one or more processors, the non-natural-language tokens into groups of tokens with similar characteristics.

Clause 4. The computer-implemented method of any of the preceding clauses, wherein identifying the at least one structured data element comprises searching for at least one data element in the predefined set of data sources, the at least one data element comprising a selection from the group consisting of: a value of at least one of the extracted non-natural-language tokens and metadata of at least one of the extracted natural language tokens.

Clause 5. The computer-implemented method of clause 4, further comprising: determining, by one or more processors, a matching score value based on a number of the at least one unrecognized tokens and recognized tokens extracted from the unstructured text document that have been found in the data element and a specificity of the extracted tokens.

Clause 6. The computer-implemented method of clause 5, further comprising selecting, by one or more processors, the data element having a highest score value as the label for the unstructured text document.

Clause 7. The computer-implemented method of any of the preceding clauses, wherein identifying the at least one structured data element comprises a selection from the group consisting of: (i) generating, by one or more processors, a structured data element comprising the extracted non-natural-language tokens as values, (ii) determining, by one or more processors, domain characteristics for the generated data element, and (iii) searching, by one or more processors, in a predefined set of data sources, for the structured data elements that share the same domain characteristics.

Clause 8. The computer-implemented method of any of the preceding clauses, wherein relating the label associated with the identified at least one structured data element to the unstructured text document further comprises outputting, by one or more processors, the related label as a label suggestion for the unstructured text document, and receiving, by one or more processors, a confirmation signal confirming the label suggestion as the confirmed label for the unstructured text document.

Clause 9. The computer-implemented method of any of the preceding clauses, wherein the predefined set of data sources are selected from the group consisting of: a database table, a data dictionary and a data catalog, a structured file in a file system a no-SQL database, and a graph database.

Clause 10. The computer-implemented method of clause 6, wherein the selected label is further ranked based on context extracted from the unstructured text document.

Clause 11. The computer-implemented method of clause 6, further comprising sorting, by one or more processors, the data elements by the search score value associated with each of the data elements and keeping only the data elements with a search score value above a search score threshold value.

Clause 12. A computer program product comprising one or more computer readable storage media, and program instructions collectively stored on the one or more computer readable storage media, the program instructions comprising program instructions to receive an unstructured text document, program instructions to extract at least one unrecognized token from the unstructured text document, program instructions to identify at least one structured data element in a predefined set of data sources, wherein the at least one structured data element is related to the at least one extracted unrecognized token from the unstructured text document, and program instructions to relate a label associated with the identified at least one structured data element to the unstructured text document.

Clause 13. The computer program product of clause 12, wherein program instructions to extract the at least one unrecognized token from the unstructured text document further comprise program instructions, collectively stored on the one or more computer readable storage media, to determine natural language elements and non-natural-language elements.

Clause 14. The computer program product of clause 13, further comprising program instructions, collectively stored on the one or more computer readable storage media, to group the non-natural-language tokens into groups of tokens with similar characteristics.

Clause 15. The computer program product of any of the clauses 12-14, wherein program instructions to identify the at least one structured data element comprise program instructions to search for at least one data element in the predefined set of data sources, the at least one data element comprising a selection from the group consisting of: a value of at least one of the extracted non-natural-language tokens and metadata of at least one of the extracted natural language tokens.

Clause 16. The computer program product of clause 15, further comprising program instructions, collectively stored on the one or more computer readable storage media, to determine a matching score value based on a number of the at least one unrecognized tokens and recognized tokens extracted from the unstructured text document that have been found in the data element and a specificity of the extracted tokens.

Clause 17. The computer program product of clause 16, further comprising program instructions, collectively stored on the one or more computer readable storage media, to select the data element having a highest score value as the label for the unstructured text document.

Clause 18. The computer program product of any of the clauses 12 to 17, wherein program instructions to identify the at least one structured data element comprise a selection from the group consisting of: (i) program instructions to generate a structured data element comprising the extracted non-natural-language tokens as values, (ii) program instructions to determine domain characteristics for the generated data element, and (iii) program instructions to search in a predefined set of data sources, for the structured data elements that share the same domain characteristics.

Clause 19. The computer program product of any of clauses 12 to 18, wherein program instructions to relate the label associated with the identified at least one structured data element to the unstructured text document further comprise program instructions, collectively stored on the one or more computer readable storage media, to output the related label as a label suggestion for the unstructured text document, and program instructions, collectively stored on the one or more computer readable storage media, to receive a confirmation signal confirming the label suggestion as the confirmed label for the unstructured text document.

Clause 20. A computer system comprising one or more computer processors, one or more computer readable storage media, and program instructions collectively stored on the one or more computer readable storage media for execution by at least one of the one or more computer processors, the program instructions comprising program instructions to receive an unstructured text document, program instructions to extract at least one unrecognized token from the unstructured text document, program instructions to identify at least one structured data element in a predefined set of data sources, wherein the at least one structured data element is related to the at least one extracted unrecognized token from the unstructured text document, and program instructions to relate a label associated with the identified at least one structured data element to the unstructured text document.

What is claimed is:

1. A computer-implemented method comprising:
receiving, by one or more processors, an unstructured text document;
extracting, by one or more processors, at least one unrecognized token from the unstructured text document;
identifying, by one or more processors, at least one structured data element in a predefined set of data sources, wherein the at least one structured data element is related to the at least one extracted unrecognized token from the unstructured text document; and
relating, by one or more processors, a label associated with the identified at least one structured data element to the unstructured text document.

2. The computer-implemented method of claim 1, wherein extracting the at least one unrecognized token from the unstructured text document further comprises:
determining, by one or more processors, natural language elements and non-natural-language elements.

3. The computer-implemented method of claim 2, further comprising:
grouping, by one or more processors, non-natural-language tokens into groups of tokens with similar characteristics.

4. The computer-implemented method of claim 1, wherein identifying the at least one structured data element comprises searching for at least one data element in the predefined set of data sources, the at least one data element comprising a selection from the group consisting of: a value of at least one of the extracted non-natural-language tokens and metadata of at least one of the extracted natural language tokens.

5. The computer-implemented method of claim 4, further comprising:
determining, by one or more processors, a matching score value based on a number of the at least one unrecognized tokens and recognized tokens extracted from the unstructured text document that have been found in the data element and a specificity of the extracted tokens.

6. The computer-implemented method of claim 5, further comprising:
selecting, by one or more processors, the data element having a highest score value as the label for the unstructured text document.

7. The computer-implemented method of claim 1, wherein identifying the at least one structured data element comprises a selection from the group consisting of: (i) generating, by one or more processors, a structured data element comprising extracted non-natural-language tokens as values, (ii) determining, by one or more processors, domain characteristics for the generated data element, and (iii) searching, by one or more processors, in a predefined set of data sources, for the structured data elements that share the same domain characteristics.

8. The computer-implemented method of claim 1, wherein relating the label associated with the identified at least one structured data element to the unstructured text document further comprises:
outputting, by one or more processors, the related label as a label suggestion for the unstructured text document; and
receiving, by one or more processors, a confirmation signal confirming the label suggestion as the confirmed label for the unstructured text document.

9. The computer-implemented method of claim 1, wherein the predefined set of data sources are selected from the group consisting of: a database table, a data dictionary and a data catalog, a structured file in a file system a no Structured Query Language (SQL) database, and a graph database.

10. The computer-implemented method of claim 6, wherein the selected label is further ranked based on context extracted from the unstructured text document.

11. The computer-implemented method of claim 6, further comprising:
sorting, by one or more processors, the data elements by the search score value associated with each of the data elements and keeping only the data elements with a search score value above a search score threshold value.

12. A computer program product comprising:
one or more computer readable storage media, and program instructions collectively stored on the one or more computer readable storage media, the program instructions comprising:
program instructions to receive an unstructured text document;
program instructions to extract at least one unrecognized token from the unstructured text document;
program instructions to identify at least one structured data element in a predefined set of data sources, wherein the at least one structured data element is related to the at least one extracted unrecognized token from the unstructured text document; and
program instructions to relate a label associated with the identified at least one structured data element to the unstructured text document.

13. The computer program product of claim 12, wherein program instructions to extract the at least one unrecognized token from the unstructured text document further comprise:
program instructions, collectively stored on the one or more computer readable storage media, to determine natural language elements and non-natural-language elements.

14. The computer program product of claim 13, further comprising:
program instructions, collectively stored on the one or more computer readable storage media, to group non-natural-language tokens into groups of tokens with similar characteristics.

15. The computer program product of claim 12, wherein program instructions to identify the at least one structured data element comprise program instructions to search for at least one data element in the predefined set of data sources, the at least one data element comprising a selection from the group consisting of: a value of at least one of the extracted non-natural-language tokens and metadata of at least one of the extracted natural language tokens.

16. The computer program product of claim 15, further comprising:
program instructions, collectively stored on the one or more computer readable storage media, to determine a matching score value based on a number of the at least one unrecognized tokens and recognized tokens extracted from the unstructured text document that have been found in the data element and a specificity of the extracted tokens.

17. The computer program product of claim 16, further comprising:
program instructions, collectively stored on the one or more computer readable storage media, to select the data element having a highest score value as the label for the unstructured text document.

18. The computer program product of claim 12, wherein program instructions to identify the at least one structured data element comprise a selection from the group consisting of: (i) program instructions to generate a structured data element comprising extracted non-natural-language tokens as values, (ii) program instructions to determine domain characteristics for the generated data element, and (iii) program instructions to search in a predefined set of data sources, for the structured data elements that share the same domain characteristics.

19. The computer program product of claim 12, wherein program instructions to relate the label associated with the identified at least one structured data element to the unstructured text document further comprise:
program instructions, collectively stored on the one or more computer readable storage media, to output the related label as a label suggestion for the unstructured text document; and
program instructions, collectively stored on the one or more computer readable storage media, to receive a confirmation signal confirming the label suggestion as the confirmed label for the unstructured text document.

20. A computer system comprising:
one or more computer processors, one or more computer readable storage media, and program instructions collectively stored on the one or more computer readable storage media for execution by at least one of the one or more computer processors, the program instructions comprising:
program instructions to receive an unstructured text document;
program instructions to extract at least one unrecognized token from the unstructured text document;
program instructions to identify at least one structured data element in a predefined set of data sources, wherein the at least one structured data element is related to the at least one extracted unrecognized token from the unstructured text document; and
program instructions to relate a label associated with the identified at least one structured data element to the unstructured text document.
